(19) United States
(12) Patent Application Publication
(10) Pub. No.: US 2003/0216912 A1
(43) Pub. Date: Nov. 20, 2003

(54) Speech recognition method and speech recognition apparatus

(76) Inventor: Tetsuro Chino, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/420,851

(22) Filed: Apr. 23, 2003

(30) Foreign Application Priority Data
Apr. 24, 2002 (JP) 2002-122861

(51) Int. Cl. G10L 15/00

(52) U.S. Cl. 704/231

(57) ABSTRACT

A speech recognition method comprises analyzing an input speech input a plurality of times to recognize the input speech and generate a plurality of recognized speech information items, detecting a rephrased speech information item corresponding to a rephrased speech from the recognition speech information items, detecting a recognition error in units of a character string from an original speech information item corresponding to the rephrased speech information item, removing an error character string corresponding to the recognition error from the original speech information item, and generating a speech recognition result by using the rephrased speech information item and the original speech information item from which the error character string is removed.

### CROSS-REFERENCE TO RELATED APPLICATIONS

This application is based upon and claims the benefit of priority from the prior Japanese Patent Application No. 2002-122861, filed Apr. 24, 2002, the entire contents of which are incorporated herein by reference.

### BACKGROUND OF THE INVENTION

1. Field of the Invention

The present invention relates to a speech recognition method and a speech recognition apparatus.

2. Description of the Related Art

In late years, practical use of a human interface using a speech input advances slowly. For example, a speech operation system, a speech input system, and a speech interaction system are developed. The speech operation system recognizes an input speech, and executes automatically an operation corresponding to a recognition result, when a user inputs, in speech, a specific command set beforehand. The speech input system analyzes an arbitrary sentence that a user inputs in speech and converts the sentence into a character string. In other words, the speech input system can draw up a sentence by a speech input. The speech interaction system makes it possible that a user interacts with the system by a spoken language. A part of these systems is already used.

A conventional speech recognition system takes in a speech uttered by a user with a microphone and the like, and converts it into a speech signal. The speech signal is sampled in units of less time, and converted to digital data such as a time sequence of, for example, a waveform amplitude by an A/D (analog to digital) converter. For example, FFT (fast Fourier transform) analysis is applied to this digital data to analyze, for example, time changes of frequency of the digital data and extract feature data of the speech signal.

In a recognition process, a similarity is computed in word between a phoneme symbol sequence of a word dictionary and a reference pattern of phoneme prepared as a dictionary beforehand. In other words, using HMM (hidden Markov model) technique, DP (dynamic programming) technique or NN (neural network) technique, a reference pattern is compared with feature data extracted from an input speech to collate them. A word similarity between a phoneme recognition result and a phoneme symbol sequence of the word dictionary is computed to generate recognition candidates for the input speech.

Further, for the purpose of improving a recognition precision, the likelihood candidate is estimated and selected from the recognized candidates, using a statistical language model represented by n-gram, for example, to recognize the input speech. However, there are following problems in the above systems.

In speech recognition, it is very difficult to recognize the input speech without error. That is, perfect recognition is impossible without limit. This is based on the following reasons.

The segmentation of a speech interval fails due to noises and the like existing in the environment where a speech is input. The decode of a recognition result fails due to a reason that the waveform of the input speech is transformed by individual differences between users such as quality of voice, volume, speech speed, an outbreak style, a dialect and so on, or an utterance method or an utterance style.

Recognition fails when a user utters the unknown word that is not prepared in the system. The word analogous acoustically to a target word is erroneously recognized. The word is misrecognized due to incompletion of prepared reference pattern and statistical language model. The candidates are narrowed down for the purpose of reducing a computation load in a decode process. In this time, a necessary candidate is erroneously deleted resulting in misrecognition. The sentence that wants to originally input are not correctly recognized due to missaying, rephrasing, grammatical ill-formedness of a spoken language and so on.

When a part of many elements included in a long speech is erroneously recognized, the speech becomes an error for the whole. When a recognition error occurs, malfunction is caused. Exclusion of the influence of the malfunction or restoration becomes necessary. This makes a user suffer a load. When a recognition error occurs, a user has to repeat the same input many times. This makes the user suffer a load. When a keyboard operation, for example, is necessary in order to revise the sentence that is misrecognized and cannot input correctly, a hands-free of speech input becomes invalid. A psychological load hangs over the user to input a speech justly; a merit of the speech input to call simplicity is canceled.

As thus described, it is impossible in the speech recognition to avoid perfectly misrecognition. Therefore, in a conventional speech recognition, there are problems that the sentence that the user wants to input into a system cannot input, that the user has to repeat the same utterance many times, and that the keyboard operation for error correction is necessary. This increases a load to the user and obstructs original advantages of the speech input such as hands-free characteristics and a simplicity.

### BRIEF SUMMARY OF THE INVENTION

It is an object of the present invention to provide a speech recognition method capable of correcting misrecognition of an input speech without a load of a user, and a speech recognizer apparatus threrefor.

According to an aspect of the invention, there is provided a speech recognition method comprising analyzing an input speech input a plurality of times to recognize the input speech and generate a plurality of recognized speech information items, detecting a rephrased speech information item corresponding to a rephrased speech from the recognition speech information items, detecting a recognition error in units of a character string from an original speech information item corresponding to the rephrased speech information item, removing an error character string corresponding to the recognition error from the original speech information item, and generating a speech recognition result by using the rephrased speech information item and the original speech information item from which the error character string is removed.

According to another aspect of the invention, there is provided a speech recognition method comprising: taking in an input speech a plurality of times to generate a plurality of input speech signals corresponding to an original speech and a rephrased speech; analyzing the input speech signal to output feature information expressing a feature of the input speech; storing recognition candidate information in a dictionary storage; collating the feature information with the dictionary storage to extract at least one recognition candidate information similar to the feature information; storing the feature information corresponding to the input speech and the extracted candidate information in a history storage; outputting interval information based on the feature information corresponding to at least two of the input speech signals and the extracted candidate information, referring to the history storage, the interval information representing at least one of a coincident interval or a similar speech interval and a non-similar interval or a non-coincident interval with respect to the rephrased speech and the original speech; and reconstructing the input speech using the candidate information of the rephrased speech and the original speech based on the interval information.

According to another aspect of the invention, there is provided a speech recognition apparatus comprising: an input speech analyzer to analyze an input speech input a plurality of times to recognize the input speech and generate a plurality of recognized speech information items; a rephrased speech detector which detects a rephrased speech information item corresponding to a rephrased speech from the recognition speech information items; a recognition error detector which detects a recognition error in units of a character string from an original speech information item corresponding to the rephrased speech information item; an error remover which removes an error character string corresponding to the recognition error from the original speech information item; and a reconstruction unit configured to reconstruct the input speech by using the rephrased speech information item and the original speech information item from which the error character string is removed.

### BRIEF DESCRIPTION OF THE SEVERAL VIEWS OF THE DRAWING

FIG. 1 is a block diagram of a speech interface apparatus related to an embodiment of the present invention.

FIGS. 2A and 2B show a flow chart for explaining an operation of the speech interface apparatus of FIG. 1.

FIG. 3 is a diagram for explaining a correction procedure of misrecognition concretely.

FIG. 4 is a diagram for explaining another correction procedure of misrecognition concretely.

### DETAILED DESCRIPTION OF THE INVENTION

There will now be described an embodiment of the present invention in conjunction with the drawings.

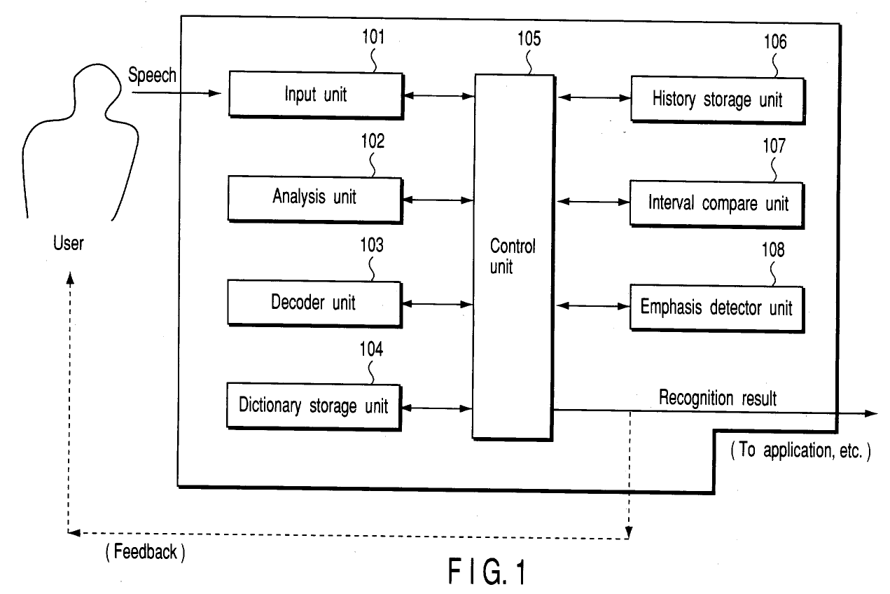

FIG. 1 shows speech interface equipment using a speech recognition method and a speech recognition apparatus according to an embodiment of the invention.

This speech interface equipment comprises an input unit 101, an analysis unit 102, a decoder unit 103, a dictionary storage unit 104,a control unit 105, a history storage unit 106, an interval compare unit 107 and an emphasis detector unit 108.

The input unit 101 takes in a speech from a user according to instructions of the control unit 105. The input unit 101 includes a phone-converter function that converts the speech into an electrical signal or speech signal, and an A/D converter function that converts the speech signal into a digital signal. Further, the input unit 101 includes a modulator function that converts the digital speech signal into digital data according to a PCM (pulse code modulation) scheme and the like. The digital data includes waveform information and feature information.

The above process performed by the input unit 101 can be executed by a process similar to digital processing of a conventional speech signal. The analysis unit 102 receives the digital data output from the input unit 101 according to instruction of the control unit 105. The analysis unit 102 outputs, every interval of the input speech (for example, phoneme unit or word unit), feature information parameters (spectra, for example) necessary for the speech recognition in a sequence, by performing a frequency analyses based on a process such as FFT (fast Fourier transformation) process. The above process performed by the analysis unit 102 can be executed by a process similar to a conventional speech analysis process.

The decoder unit 103 receives feature information parameters output from the analysis unit 102 according to the instruction of the control unit 105. The decoder unit 103 collates the feature information parameters with the dictionary stored in the dictionary storage unit 104. In this time, the similarity between the feature information parameters and the dictionary is computed every input speech interval (for example, a phoneme string unit such as a phoneme or a syllable or an accent phrase or a character string unit such as a word unit). A plurality of recognition candidates of character strings or phoneme strings are generated according to the score of the similarity. The process of the decoder unit 103 can be realized by a process similar to a conventional speech recognition process such as HMM (Hidden Markov Model), a DP (Dynamic Programming) or an NN (Neural Network) process.

The dictionary storage unit 104 stores a dictionary used when the decode process is executed with respect to the reference pattern such as a phoneme or a word by the decoder unit 103. The control unit 105 controls the input unit 101, the analysis unit 102, the decoder unit 103, the dictionary storage unit 104, the history storage unit 106, the interval compare unit 107 and the emphasis detector unit 108 to perform the speech recognition. In other words, under control of the control unit 105, the input unit 101 takes in a speech of a user (a speaker) and outputs digital data. The analysis unit 102 analyzes the digital data and extracts feature information parameters.

The decoder unit 103 collates the feature information parameters with the dictionary stored in the dictionary storage unit 104, and outputs at least one recognition candidate concerning the speech input from the input unit 101 along with the similarity. The decoder unit 103 embraces (selects) a recognition candidate most likely to be the input speech from the recognition candidates based on the similarity. The recognition result is provided for the user in form of a letter or a speech. Alternately, it is output to an application behind the speech interface.

The history storage unit 106, the interval compare unit 107 and the emphasis detector unit 108 are characteristics of the present embodiment. The history storage unit 106 stores, for each input speech, the digital data corresponding to the input speech which is generated by the input unit 101, the feature information parameters extracted from the input speech by the analysis unit 102, the recognition candidates and recognition result concerning the input speech that are provided by the decoder unit 103 as the history information on the input speech.

The interval compare unit 107 detects a similar part between two speeches (similar section) and a difference part (inconsistent section) based on the history information of two input speeches input in succession and stored in the history storage 106. The similar section and inconsistent section are determined by the similarity computed with respect to each recognition candidate that is obtained by the digital data included in the history information of two input speeches, the feature information parameters extracted from the digital data, and DP (dynamic programming) process to the feature information.

In the interval compare unit 107, an interval during which a character string such as a phoneme string or a word is assumed to be spoken is detected, as the similar interval, from feature information parameters extracted from the digital data in for each interval of two input speeches (for example, a phoneme string unit such as a phoneme, a syllable, an accent phrase or a character string unit such as a word), and recognition candidates concerning the feature information parameters.

The interval that is not determined as a similar interval between two speeches is an inconsistent interval. The feature information parameter (for example, spectra) is extracted from the digital data for speech recognition every interval of the input speech as two time-series signals which are input in succession (for example, phoneme string unit or character string unit). When the feature information parameters are continuously similar during a given interval, the interval is detected as the similar interval. Alternatively, a plurality of phoneme strings or character strings as recognition candidates are generated every interval of two input speeches.

When the interval that a ratio of the phoneme string or character string to be common to two speeches to the plurality of phoneme strings or character strings is not less than a given ratio is continue during a given period, the interval is detected as the similar interval common to two speeches. That “the feature information parameters are continuously similar during a given time” means that the feature information parameters are similar during a period sufficient for determining that two input speeches generate the same phrases.

When the similar interval is detected from the two input speeches continuously inputted, the interval other than the similar interval is the inconsistent interval in each of the input speeches. If the similar interval is not detected from two input speeches, the whole interval of the input speeches is an inconsistent interval.

The interval compare unit 107 may extract prosodic features such as a pattern of a time change of a fundamental frequency F0 (a fundamental frequency pattern) from the digital data of each input speech.

There will now be described a similar interval and an inconsistent interval concretely. Assuming that misrecognition causes in a part of a recognition result for the first input speech, and a speaker speaks the same phrase to be recognized again.

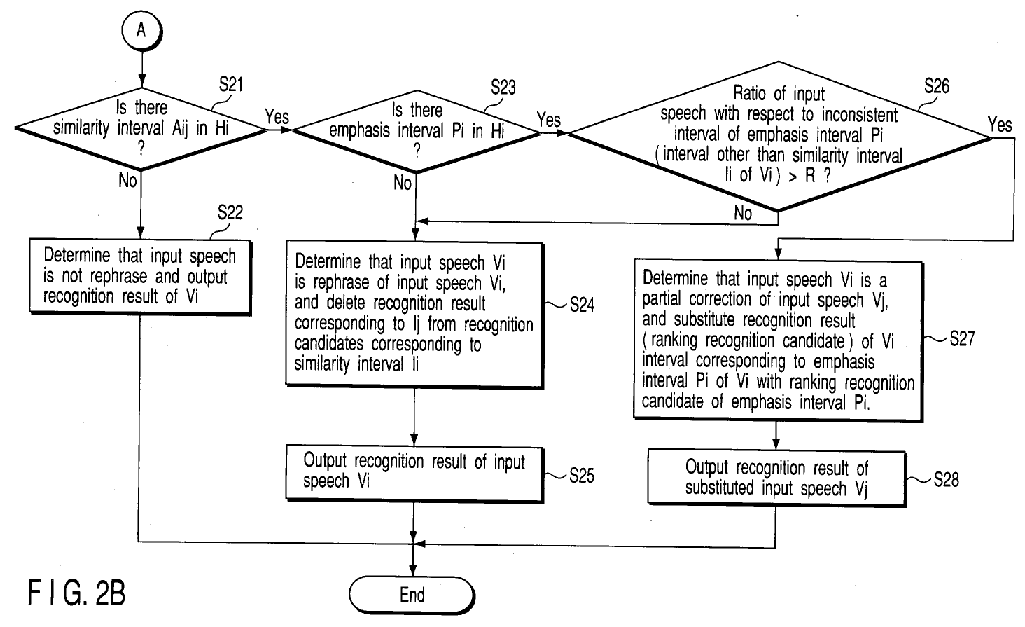

It is assumed that a user (speaker) speaks a phrase “Chiketto wo kaitai no desuka? (Do you want to buy a ticket?)”. Assuming that this speech is the first input speech. This first input speech inputs from the input unit 101. The decoder unit 103 recognizes the first input speech as “Raketto ga kaunto nanodesu” as shown at (a) in FIG. 3. The user speaks again a phrase “Chiketto wo kaitai nodesuka? ” as shown at (b) in FIG. 3. Assuming that this speech is the second input speech. In this case, since the feature information parameters of the phoneme string or character string that express “Raketto ga” and “chiketto wo” which are extracted from the first and second input speeches respectively are similar, the interval compare unit 107 detects the interval of the same phoneme string or character string as the similar interval.

Since the interval of the phoneme string or character string that expresses “nodesu” of the first input speech and the interval of the phoneme string or character string that expresses “nodesuka” of the second input speech are similar in feature information parameters, these intervals are detected as the similar interval. The intervals other than the similar interval in the first and second input speeches are detected as the inconsistent interval. In this case, the interval of the phoneme string or character string that expresses “kauntona” of the first input speech and the interval of the phoneme string or character string that expresses “kaitai” of the second input speech are not similar in the feature information parameters. As a result, since the phoneme string or character string given as a recognition candidate does not almost includes common elements, the similar interval is not detected. Therefore, these intervals are detected as the inconsistent interval.

Since the first and the second input speeches assume to be similar phrases (preferably the same phrases), if the similar interval is detected from two input speeches as described above (that is, if the second input speech assumes to be a partial rephrase (or repeat) of the first input speech), the coincident relation between the similar intervals of two input speeches and the inconsistent relation between the inconsistent intervals thereof are shown at (a) and (b) in FIG. 3.

When the interval compare unit 107 detects the similar interval from the digital data for each interval of two input speeches, it may detect the similar interval in consideration with at least one of prosodic features such as speech speeds of two input speeches, utterance strengths, pitches corresponding to a frequency variation, appearance frequency of the pause that is a unvoiced interval, and a voice quality, as well as the feature information extracted for the speech recognition. When the interval to be in the border that can be determined as the similar interval is similar to at least one of the prosodic features, the corresponding interval may be detected as the similar interval.

As thus described, the detection accuracy of the similar interval is improved by determining whether the interval is the similar interval on the basis of the prosodic feature as well as the feature information such as a spectra. The prosodic feature of each input speech can be obtained by extracting a time variation pattern of a fundamental frequency F0 (fundamental frequency pattern) from the digital data of each input speech. The technique to extract this prosodic feature is a well-known public technique.

The emphasis detector unit 108 extracts the time variation pattern of the fundamental frequency F0 (fundamental frequency pattern) from the digital data of the input speech, for example, on the basis of history information stored in the history storage unit 106. Also, the emphasis detector unit 108 extracts a time variation of the power that is the strength of the speech signal, and analyzes the prosodic feature of the input speech, thereby to detect, from the input speech, an interval during which a speaker utters in emphasis.

Conventionally, it can be predicted that the speaker emphasizes the part that he or her wants to rephrase (or repeat) when he or she wants to rephrase partially. Feeling of the speaker appears as a prosodic feature of the speech. On the basis of this prosodic feature, the emphasis interval can be detected from the input speech. The prosodic feature of the input speech that is detected as the emphasis interval is also represented by the fundamental frequency pattern. The prosodic features are expressed as following:

The speech speed of a certain interval in the input speech is more late than the interval other than the input speech. The utterance strength of the certain interval is stronger than other interval. The pitch that is a frequency variation in the certain interval is higher than other interval. The appearance of the pause that is an unvoiced interval in the certain interval is frequent. The voice quality in the certain interval is a reedy voice (for example, the average of the fundamental frequency is higher than other interval). When at least one of these prosodic features satisfies a given standard that can be determined as the emphasis interval, and further when the feature appears continuously in a given time interval, the interval is determined as the emphasis interval.

The history storage unit 106, the interval compare unit 107 and the emphasis detector unit 108 are controlled by the control unit 105.

In the present embodiment, there will be explained an example using character string as a recognition candidate and a recognition result. However, for example, a phoneme string may be used as a recognition candidate and a recognition result. The internal processing that the phoneme string is used as the recognition candidate is the same as the processing that the character string is used as the recognition candidate as follows. The phoneme string obtained as the recognition result may be finally output in speech, and may be output as a character string.

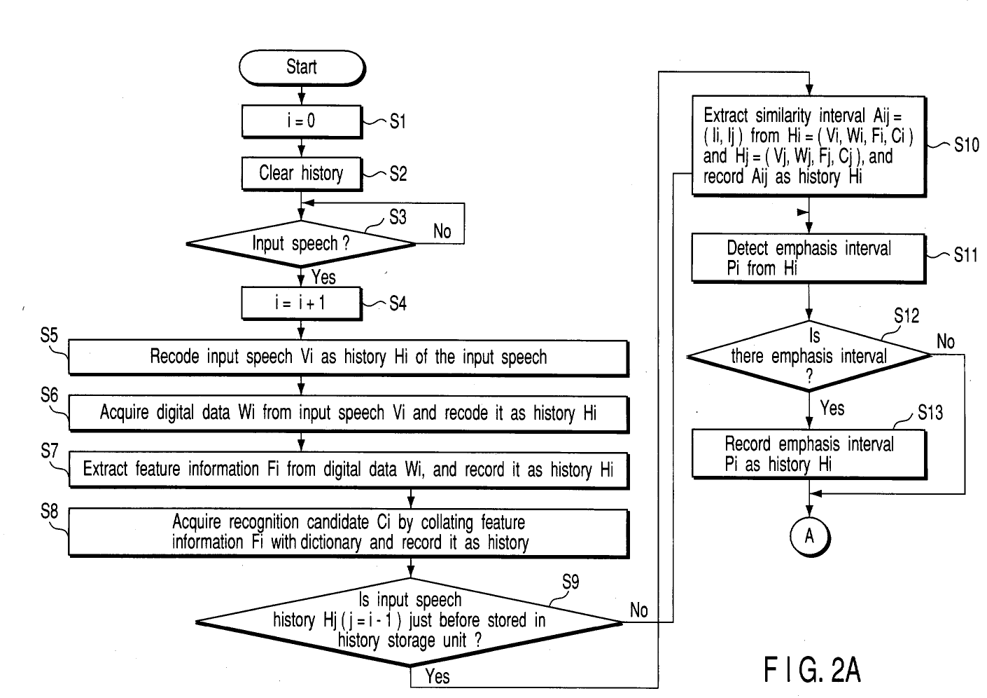

The operation of the speech interface apparatus shown in FIG. 1 will be described referring to the flowchart of FIGS. 2 and 3.

The control unit 105 controls the units 101-104 and 106-108 so that the units execute operations shown in FIGS. 2A and 2B. The control unit 105 resets a counter value I corresponding to an identifier (ID) concerning the input speech to “0”, and deletes (clears) all the history information parameters stored in the history storage unit 106, to initialize the system (steps S1 and S2).

When a speech is input (step S3), the counter value is incremented by one (step S4) to set the counter value i to ID of the input speech. The input speech is referred to Vi. The history information of this input speech Vi is Hi (hereinafter refer to history Hi).

The input speech Vi is recorded as the history Hi in the history storage unit 106 (step S5). The input unit 101 subjects the input speech Vi to an analogue-to-digital conversion to generate digital data Wi corresponding to the input speech Vi. The digital data Wi is stored in the history storage unit 106 as the history Hi (step S6). The analysis unit 102 analyzes the digital data Wi to generate feature information Fi of the input speech Vi, and stores the feature information Fi as history Hi in the history storage unit 106 (step S7).

The decoder unit 103 collates a dictionary stored in the dictionary storage unit 104 with the feature information Fi extracted from the input speech Vi, and generates, as recognition candidates Ci, a plurality of character strings in units of a word, for example, that correspond to the input speech Vi. The recognition candidates Ci are stored in the history storage unit 106 as the history Hi (step S8).

The control unit 105 searches the history storage unit 106 for history Hj (j=i−1) of the input speech just before the input speech Vi (step S9). If the history Hj exists in the history storage unit 106, the process advances to step S10 to detect the similar interval. If the history Hj does not exist in the history storage unit 106, the step S10 is skipped and the process advances to step S11.

In step S10, on the basis of the history. Hi of the current input speech=(Vi, Wi, Fi, Ci, . . . ) and the history Hj of the input speech just before=(Vj, Wj, Fj, Cj, . . . ), the similar interval Aij=(Ii, Ij) is extracted and recorded as the history Hi in the history storage unit 106. The interval compare unit 107 detects the similar interval on the basis of, for example, the digital data (Wi, Wj) every given interval of the current input speech and the input speech just before and feature information parameters (Fi, Fj) extracted from the digital data, and, if necessary, recognition candidates (Ci, Cj) or prosodic features of the current input speech and the input speech just before.

The similar intervals corresponding to the input speech Vi and the input speech Vj just before are expressed with Ii and Ij. The relation between these similar intervals is expressed with Aij=(Ii, Ij). The information concerning the similar interval Aij of two detected consecutive input speeches is stored as history Hi in the history storage unit 106. Assuming that the previous input speech Vj is referred to the first input speech, and the current input speech Vi to the second input speech.

In step S11, the emphasis detector unit 108 extracts the prosodic feature from the digital data Fi of the second input speech Vi to detect the emphasis interval Pi from the second input speech Vi. The following standard (alternatively, rule) predetermined for determining the emphasis interval is stored in the emphasis detector unit 108.

A rule that if the speech speed in a certain interval in the input speech is lower by a given value than that in another interval of the input speech, the certain interval is determined as the emphasis interval.

A rule that if the utterance strength in the certain interval is stronger by a given value than that in another interval, the certain interval is determined as the emphasis interval.

A rule that if the pitch corresponding to a frequency variation in the certain interval is higher by a given value than another interval, the certain interval is determined as the emphasis interval.

A rule that if the appearance frequency of the pause corresponding to an unvoiced interval in the certain interval is bigger by a given value than another interval, the certain interval is determined as the emphasis interval.

A rule that if the voice quality in the certain interval is shriller by a give value than another interval (if the average of, for example, a fundamental frequency is higher by a given value than another interval), the certain interval is determined as the emphasis interval.

If at least one of the plurality of rules or some of them is satisfied, the certain interval is determined as the emphasis interval.

When the emphasis interval Pi is detected from the second input speech Vi (step S12) as described above, the information concerning the detected emphasis interval Pi is stored in the history storage unit 106 as history Hi (step S13).

The processing shown in FIG. 2A is the recognition process on the second input speech Vi. The recognition result is already provided with respect to the first input speech Vj. However, the recognition result is not yet provided with respect to the second input speech Vi.

The control unit 105 searches the history storage unit 106 for the history Hi on the second input speech, i.e., the current input speech Vi. If the information on the similar interval Aij is not included in the history Hi (step S21 of FIG. 3), it is determined that the input speech is not the speech obtained by rephrasing the speech Vj input just before the current input speech.

The control unit 105 and the decoder unit 103 select a character string most similar to the input speech Vi from the recognition candidates obtained in step S8, and output recognition result on the input speech Vi (step S22). The recognition result of the input speech Vi is stored in the history storage unit 106 as history Hi.

On the other hand, the control unit 105 searches the history storage unit 106 for the history Hi on the second input speech, that is, the input speech Vi. If the information on the similar interval Aij is included in the history Hi (step S21 of FIG. 3), it is determined that the input speech is the speech obtained by rephrasing the speech Vj input just before the input speech Vi. In this case, the process advances to step S23.

Whether information on the emphasis interval Pi is included in history Hi is determined in step S23. When the determination is NO, the process advances to step S26. When the determination is YES, the process advances to step S24.

In step S24, the recognition result is generated with respect to the second input speech Vi. In this time, the control unit 105 deletes a character string of the recognition result corresponding to the similar interval Ij of the first input speech Vi from recognition candidates corresponding to the similar interval Ii of the second input speech Vi (step S24). The decoder unit 103 selects a plurality of character strings most similar to the second input speech Vi from the recognition candidates corresponding to the second input speech Vi, and generates a recognition result of the second input speech Vi to output it as a corrected recognition of the first input speech (step S25). The recognition result generated in step S25 as the recognition result of the first and second input speeches Vj and Vi is stored in the history storage 106 as histories Hj and Hi.

The process of the steps S24 and S25 is described referring to FIG. 3 concretely. In FIG. 3, as explained above, since the first input speech input by the user is recognized as “Raketto ga kaunto nanode” (at (a) in FIG. 3), the user inputs “Chiketto wo kaitai nodesuka” as the second input speech. Then, in steps S10 to S13 of FIG. 2A, the similar interval and the inconsistent interval are detected from the first and second input speeches as shown in FIG. 3. It is assumed that the emphasis interval is not detected from the second input speech.

The decoder unit 103 collates with a dictionary with respect to the second input speech (step S8 in FIG. 2A). As a result, it is assumed that the recognition result shown in FIG. 3 is obtained. In the interval during which “chiketto wo” is uttered, character strings such as “raketto ga”, “chiketto wo”, . . . , are generated as recognition candidates. In the interval during which “Kaitai” is uttered, character strings such as “kaitai”, “kaunto”, . . . , are generated as recognition candidates. Further, in the interval during which “nodesuka” is uttered, character strings such as “nodesuka”, “nanodesuka”, . . . , are generated as recognition candidates.

In step S24 of FIG. 3, the interval (Ii) of the first input speech during which “chiketto ga” is uttered and the interval (Ij) of the first input speech during which “raketto” is recognized are the similar interval. Therefore, the character string “raketto ga” that is the recognition result of the similar interval Ij is deleted from the recognition candidates of the interval of the second input speech during which “chiketto ga” is uttered. If the number of recognition candidates is more than a given number, the character string, for example, “raketto wo” similar to the character string “raketto ga” that is the recognition result of the similar interval Ij in the first input speech may be further deleted from the recognition candidates in the interval of the second input speech during which “chiketto wo” is uttered.

The interval (Ii) of the second input speech during which “nodesuka” is uttered and the interval of the first input speech during which “nodesu” is uttered (Ii) are the similar interval with respect to each other. The character string “nodesu” that is a recognition result of the similar interval Ij in the first input speech is deleted from the recognition candidates in the interval of the second input speech during which “nodesuka” is uttered. As a result, the recognition candidates in the interval of the second input speech during which “chiketto wo” is uttered are, for example, “chiketto wo”, “chiketto ga.” This is a result obtained by being narrowed down based on a recognition result of the previous input speech.

The recognition candidates in the interval of the second input speech during which “nodesuka” is uttered are, for example, “nanodesuka”, “nodesuka”. This is a result obtained by being narrowed down based on a recognition result of the previous input speech.

In step S25, the character string most similar to the second input speech Vi is selected from the character strings of the recognition result narrowed down to generate a recognition result. In other words, the character string most similar to the speech of the interval of the second input speech during which “chiketto wo” is uttered is “chiketto wo” in the character strings of the recognition candidates in the interval. The character string most similar to the speech of the interval of the second input speech during which “kaitai” is uttered is “kaitai” in the character strings of the recognition candidates in the interval. The character string most similar to the speech of the interval of the second input speech during which “nodesuka” is uttered is “nodesuka” in the character strings of the recognition candidates in the interval. As a result, the character string (sentence) of “chiketto wo kaitai nodesuka” is generated from the selected character string as corrected recognition result of the first input speech.

The process of steps S26 to S28 of FIG. 2B will be described. When the emphasis interval is detected from the second input speech and approximately equal to the inconsistent interval, the recognition result of the first input speech is corrected based on the recognition candidate corresponding to the emphasis interval of the second input speech. Even if the emphasis interval is detected from the second input speech as indicated in FIG. 2B, when a ratio of the emphasis interval Pi to the inconsistent interval is not more than a given value R (step S26), the process advances to step S24. Similarly to the above, the recognition result of the second input speech is generated by narrowing down the recognition candidates obtained with respect to the second input speech based on the recognition result of the first input speech.

In step S26, the emphasis interval is detected from the second input speech. Further, when the emphasis interval is approximately equal to the inconsistent interval (a ratio of the emphasis interval Pi to the inconsistent interval is not less than a given value R), the process advances to step S27.

In step S27, the control unit 105 substitutes the character string of the recognition result of the interval of the first input speech Vj corresponding to the emphasis interval Pi detected from the second input speech Vi (approximately, the interval corresponding to the inconsistent interval between the first input speech Vj and the second input speech Vi) for the character string (ranking recognition candidate) most similar to the speech of the emphasis interval selected from the character strings of recognition candidates of the emphasis interval of the second input speech Vi by the decoder unit 103, thereby to correct the recognition result of the first input speech Vj. The character string of the recognition result of the first input speech in the interval of the first input speech corresponding to the emphasis interval detected from the second input speech is substituted for the character string of the ranking recognition candidate of the emphasis interval of the second input speech, thereby to output an updated recognition result of the first input speech (step S28). The recognition result of the first input speech Vj that is partially corrected is stored in the history storage unit 106 as history Hi.

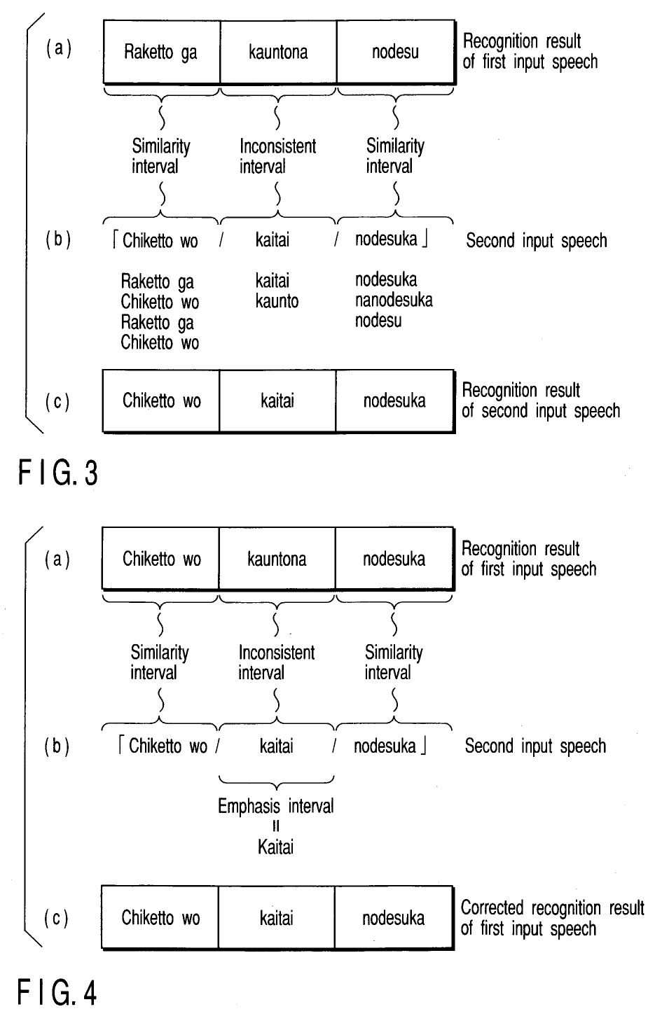

The process of steps S27 and S28 will be described referring to FIG. 4 concretely. It is assumed that the user (speaker) utters a sentence of “Chiketto wo kaitai nodesuka” in the first speech input. Assuming that this sentence is the first input speech. This first input speech is input to the decoder unit 103 through the input unit 101 to be subjected to a speech recognition. As a result of the speech recognition, it is assumed that the first input speech is recognized to be “Chiketto wo/kauntona/nodesuka” as indicated at (a) in FIG. 4. The user assumes that he or she utters the sentence of “Chiketto wo kaitai nodesuka” again as indicated at (b) in FIG. 4. Assuming that this sentence is the second input speech.

The interval compare unit 107 detects the interval during which the character string of “chiketto wo” of the first input speech is detected as the recognition result and the interval corresponding to the phrase “chiketto wo” of the second input speech as the similar interval, based on feature information parameters for the speech recognition that are extracted from the first and second input speeches respectively. The interval during which the character string of “nodesuka” of the first input speech is adopted (selected) as the recognition result and the interval corresponding to the phrase “nodesuka” of the second input speech are detected as the similar interval.

On the other hand, the intervals of the first and second input speeches other than the similar interval, that is, the interval during which the character string of “kauntona” of the first input speech is selected as the recognition result, and the interval corresponding to the phrase “kaitai” of the second input speech are detected as the inconsistent interval, because they are not detected as the similar interval by the reasons that the feature information parameters of the intervals are not similar (that is, they do not satisfy the rule for determining the similarity, and the character strings nominated for the recognition candidate include no common parameter). In steps S11 to S13 of FIG. 2A, assuming that the interval of the second input speech during which “kaitai” is uttered is detected as the emphasis interval.

The decoder unit 103 collates with a dictionary with respect to the second input speech (step S8 of FIG. 2A). As a result, the character string of, for example, “kaitai (mor phemes)” is obtained as the ranking recognition candidate with respect to the interval during which the phrase “kaitai (phonemes)” is uttered (cf. (b) in FIG. 4). In this case, the emphasis interval detected from the second input speech coincides with the inconsistent interval between the first input speech and the second input speech. Therefore, the process advances to steps S26 and S27 in FIG. 2B.

In step S27, the character string of the recognition result in the interval of the first input speech Vj that corresponds to the emphasis interval Pi detected from the second input speech Vi is substituted for the character string (the ranking recognition candidate) most similar to the speech of the emphasis interval selected from the character strings of the recognition candidates of the emphasis interval of the second input speech Vi by the decoder unit 103. In FIG. 4, the phrase “kauntona” is substituted for the phrase “kaitai”. In step S28, the character string “kauntona” corresponding to the inconsistent interval of the first recognition result “chiketto wo/kauntona/nodesuka” of the first input speech is substituted for the character string “kaitai” that is the ranking recognition candidate of the emphasis interval of the second input speech. As a result, “Chiketto wo/kaitai/nodesuka” as shown at (c) in FIG. 4 is output.

As thus described, in the present embodiment, when the first input speech of, for example, “Chiketto wo kaitai nodesuka” is recognized as “Chiketto wo kaunto nanodesuka” by mistake, the user rephrases the sentence as the second input speech to correct a misrecognized part (interval), for example. In this case, the part to be corrected is uttered dividing into syllables as being “Chiketto wo kaitai nodesuka”. As a result, the part “kaitai” uttered dividing into the syllable is detected as the emphasis interval.

When the first and second input speeches are the speech that the user uttered the same phrase, the interval other than the emphasis interval that is detected from the rephrased second input speech (or the repeated second input speech) can be regarded substantially as the similar interval.

In the present embodiment, the recognized character string of the interval of the first input speech that corresponds to the emphasis interval detected from the second input speech is substituted for the recognized character string of the emphasis interval of the second input speech to correct the recognition result of the first input speech.

An example which applies the present invention to an English sentence will be described.

When “Can you suggest a good restaurant” is input as the first input speech, it is assumed that the recognition result is “Can you majest a good restaurant”. In this recognition, “majest” becomes misrecognition. Thus “Can you suggest a good restaurant” is input as the second input speech again. The word “suggest” is input with being emphasized in the second input speech. In other words, the second input speech is input as “Can you <p>sug-gest<p> a good restaurant.”<p>sug-gest<p> means that the word “suggest” is pronounced emphatically, i.e., it is done slowly, strongly or word by word by pausing before and after the word. The second input speech shows the following features.

Similar part=Can you

Similar part=a good restaurant

Emphasis part=<p>sug-gest<p>

It is assumed that the following recognition candidates are generated by speech-recognizing the second input speech.

Can you majest a good restaurant

Can you suggest a good restaurant

Can you magenta a good restaurant

The emphasis part other than “Can you” and “a good restaurant” is recognized. The low-ranking candidates of “majest” and “magenta” are removed and the ranking candidate “suggest” is adopted. Therefore, “Can you suggest a good restaurant” is output as a recognition result by recognition of the second input speech.

The process shown in FIGS. 2A and 2B can be programmed so as to be executable by a computer. The program is stored in recording media such as a magnetic disk (a floppy disk, a hard disk), a Laser Disk (CD-ROM, DVD), a semiconductor storage, etc. to be distributed.

As described above, by removing the character string of a part of a recognition result of the first input speech that the possibility of misrecognition is high (a part (similar interval) similar to the second input speech) from recognition candidates of a rephrased input speech (or repeated input speech) (the second input speech) of the first input speech, it is avoided that the recognition result of the second input speech becomes the same as that of the first input speech. In other words, when speeches input plural times, the previous speech and the following speech are analyzed and compared, to examine whether the following speech is a rephrased speech. If the following speech is the rephrased speech, the relation between the previous speech and the following speech is examined in units of a character string. If the character string of a part of the previous speech causes recognition error, the character string of the recognition error is removed. If the previous speech from which the errored character string is removed is combined with the rephrased speech, the errored character string is substituted for the recognized character string of the rephreased speech. As a result, the speech is correctly recognized. The speech recognition is correctly performed by rephrasing. Therefore, even if the rephrasing is performed several times, the same recognition result does not occur. Thus, the recognition result of the input speech can be corrected at a high accuracy and at a high speed.

When the input speech (the second input speech) rephrasing with respect to the first input speech (the first input speech) is input, the user may utter emphasizing the part to be corrected in the recognition result of the first input speech. As a result, the to-be-corrected recognized character string of the first input speech is substituted for the most likelihood character string in the emphasis part (emphasis interval) of the second input speech to correct an error part of the recognition result of the first input speech (character string).

In the embodiment, when correcting a recognition result of the first input speech partially, it is desirable to utter emphasizing a part of the second input speech to be corrected. In this case, it may be performed to provide a method of uttering with emphasizing (how to put prosodic feature) to the user beforehand or to provide a correction method of correcting a recognition result of an input speech in using the present apparatus.

As thus described, detection accuracy of emphasis interval or similar interval can be improvded by setting up a phrase to correct the input speech beforehand (utter the same phrase as the first speech input in the case of the second speech input) or predetermining how to utter a part to be corrected to detect the part as an emphasis interval.

A partial correction may be performed by taking out a formulaic phrase for use in a correction by means of, for example, a word spotting technique. In other words, As shown in FIG. 3, when the first input speech is misrecognized as “Chiketto wo kaunto nanodesuka”, that, for example, a user seems to be “kaunnto dehanaku kaitai.” Assuming that the user inputs a predetermined phrase for a correction such as “B rather than A” which is expression of a fixed form for a partial correction.

Further, assuming that “kaunnto” and “kaitai” corresponding to “A” and “B” are uttered with increasing pitches (fundamental frequency) in the second input speech. In this case, by analyzing also this prosodic feature, expression of a fixed form for the correction is extracted. As a result, a part similar to “kaunto” is searched from a recognition result of the first input speech, The part may be substituted for the character string of “kaitai” which is a recognition result for “B” in the second input speech. In this case, “Chiketto wo kaunto nanodesuka” which is the recognition result of the first input speech is corrected, resulting in that the input speech is correctly recognized as “chiketto wo kaitai nodesuka.” After the recognition result has been confirmed by the user as in the conventional interactive system, it may be applied appropriately.

In the embodiment, two consecutive input speeches are used as a process object. However, an arbitrary number of input speeches may be used for speech recognition. In the embodiment, an example to correct a recognition result of input speech partially is described. However, for example, may adapt itself by similar technique as against until the last or the whole halfway or halfway from the top. For example, the part from the top to the middle or the part from the middle to the last or the whole may be corrected by the similar technique.

According to the embodiment, if the speech input for a correction is performed once, a plurality of parts of a recognition result of the input speech before it. The same correction may be applied to a plurality of input speeches. The speech input with another method such as a specific speech command or key operation may notify an object for use in a correction of a recognition result of the speech which input beforehand.

When the similar interval is detected, some displacement may permit by means of setting a quantity of margin beforehand.

The technique concerning the above embodiment does not use for selection of recognition candidate but used for a fine adjustment of the evaluation score which is used for, for example, the recognition process (for example, similarity) on the pre-stage.

According to the current invention, correcting misrecognition as opposed to input speech easily without hanging a burden in a user can be made.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A speech recognition method comprising:
analyzing an input speech input a plurality of times to recognize the input speech and generate a plurality of recognized speech information items;
detecting a rephrased speech information item corresponding to a rephrased speech from the recognition speech information items;
detecting a recognition error in units of a character string from an original speech information item corresponding to the rephrased speech information item;
removing an error character string corresponding to the recognition error from the original speech information item; and
generating a speech recognition result by using the rephrased speech information item and the original speech information item from which the error character string is removed.

2. A speech recognition method according to claim 1, wherein the rephrased speech includes an emphasis speech.

3. A speech recognition method according to claim 1, wherein generating the speech recognition result includes combining the original speech information item from which the error character string is removed with a rephrased character string of the rephrased speech information item, the rephrased character string corresponding to the error character string.

4. A speech recognition method comprising:
receiving an input speech a plurality of times to generate a plurality of input speech signals corresponding to an original speech and a rephrased speech;
analyzing the input speech signals to output feature information expressing a feature of the input speech;
collating the feature information with a dictionary storage to extract at least one recognition candidate information similar to the feature information;
storing the feature information corresponding to the input speech and the extracted candidate information in a history storage;
outputting interval information based on the feature information corresponding to at least two of the input speech signals and the extracted candidate information, referring to the history storage, the interval information representing at least one of one of a coincident interval and a similar speech interval and one of a non-similar interval and a non-coincident interval with respect to the rephrased speech and the original speech; and
reconstructing the input speech using the candidate information of the rephrased speech and the original speech based on the interval information.

5. The speech recognition method according to claim 4, wherein outputting the interval information includes analyzing at least one of prosodic features including an speech speed of the input speech, an utterance strength, a pitch representing a frequency variation, an appearance of a pause corresponding to an unvoiced interval, a quality of voice, and an utterance way.

6. The speech recognition method according to claim 4, wherein outputting the interval information includes analyzing at least one of waveform information, feature information and candidate information that concern to the rephrased speech, to detect a specific expression for error correction and to output the interval information.

7. The speech recognition method according to claim 4, wherein outputting the interval information includes extracting emphasis interval information representing an interval during which emphasis utterance is performed, by analyzing at least one of waveform information, feature information and candidate information that correspond to the rephrased speech, and reconstructing the input speech including reconstructing the input speech from the candidate information on the rephrased speech and the original speech, based on at least one of the interval information and the emphasis interval information.

8. The speech recognition method according to claim 7, wherein outputting the interval information includes analyzing at least one of prosodic features including a speech speed of the speech, an utterance strength, a pitch representing a frequency variation, an appearance of a pause corresponding to an unvoiced interval, a quality of voice, and an utterance way, to extract the emphasis interval information.

9. The speech recognition method according to. Claim 7, wherein extracting the emphasis interval information includes detecting a specific expression for correction to extract the emphasis interval information

10. A speech recognition apparatus comprising:
an input speech analyzer to analyze an input speech input a plurality of times to recognize the input speech and generate a plurality of recognized speech information items;
a rephrased speech detector to detect a rephrased speech information item corresponding to a rephrased speech from the recognition speech information items;
a recognition error detector to detect a recognition error in units of a character string from an original speech information item corresponding to the rephrased speech information item;
an error remover to remove an error character string corresponding to the recognition error from the original speech information item; and
a reconstruction unit to reconstruct the input speech by using the rephrased speech information item and the original speech information item from which the error character string is removed.

11. A speech recognition apparatus according to claim 10, wherein the rephrased speech includes an emphasis speech.

12. A speech recognition apparatus according to claim 10, wherein the reconstruction unit includes a combination unit to combine the original speech information item from which the error character string is removed with a rephrased character string of the rephrased speech information item, the rephrased character string corresponding to the error character string.

13. A speech recognition apparatus comprising:
a speech input unit to receive an input speech a plurality of times to generate a plurality of input speech signals corresponding to an original speech and a rephrased speech;
a speech analysis unit to analyze the input speech signal to output feature information expressing a feature of the input speech;
a dictionary storage which stores recognition candidate information;
a collation unit configured to collate the feature information with the dictionary storage to extract at least one recognition candidate information similar to the feature information;
a history storage to store the feature information corresponding to the input speech and the extracted candidate information;
an interval information output unit to output interval information based on the feature information corresponding to at least two of the input speech signals and the extracted candidate information, referring to the history storage, the interval information representing at least one of one of a coincident interval and a similar speech interval and one of a non-similar interval and a non-coincident interval with respect to the rephrased speech and the original speech; and
a reconstruction unit to reconstruct the input speech using the candidate information of the rephrased speech and the original speech based on the interval information.

14. The speech recognition apparatus according to claim 13, wherein the interval information output unit includes an analyzer to analyze at least one of prosodic features including a speech speed of the input speech, an utterance strength, a pitch representing a frequency variation, an appearance of a pause corresponding to an unvoiced interval, a quality of voice, and an utterance way.

15. The speech recognition apparatus according to claim 13, wherein the interval information output unit includes an analyzer to analyze at least one of waveform information, feature information and candidate information that concern to the rephrased speech, to detect a specific expression for error correction and to output the interval information.

16. The speech recognition apparatus according to claim 13, wherein the interval information output unit includes an emphasis interval extractor to extract emphasis interval information representing an interval during which emphasis utterance is performed, by analyzing at least one of waveform information, feature information and candidate information that correspond to the rephrased speech, and the reconstruction unit includes a reconstruction unit to reconstruct the input speech from the candidate information on the rephrased speech and the original speech, based on at least one of the interval information and the emphasis interval information.

17. The speech recognition apparatus according to claim 16, wherein the interval information output unit includes an analyzer to analyze at least one of prosodic features including a speech speed of the speech, an utterance strength, a pitch representing a frequency variation, an appearance of a pause corresponding to an unvoiced interval, a quality of voice, and an utterance way, to extract the emphasis interval information.

18. The speech recognition apparatus according to claim 16, wherein the analyzer includes a detector to detect a specific expression for correction to extract the emphasis interval information

19. A speech recognition program stored on a computer readable medium comprising:
means for instructing a computer to analyze an input speech input a plurality of times to recognize the input speech and generate a plurality of recognized speech information items;
means for instructing the computer to detect a rephrased speech information item corresponding to a rephrased speech from the recognition speech information items;
means for instructing the computer to detect a recognition error in units of a character string from an original speech information item corresponding to the rephrased speech information item;
means for instructing the computer to remove an error character string corresponding to the recognition error from the original speech information item; and
means for instructing the computer to generate a speech recognition result by using the rephrased speech information item and the original speech information item from which the error character string is removed.

20. A speech recognition program stored on a computer readable medium comprising:
means for instructing the computer to take in an input speech a plurality of times to generate a plurality of input speech signals corresponding to an original speech and a rephrased speech;
means for instructing the computer to analyze the input speech signal to output feature information expressing a feature of the input speech;
means for instructing the computer to collate the feature information with a dictionary storage to extract at least one recognition candidate information similar to the feature information;
means for instructing the computer to store the feature information corresponding to the input speech and the extracted candidate information in a history storage;
means for instructing the computer to output interval information based on the feature information corresponding to at least two of the input speech signals and the extracted candidate information, referring to the history storage, the interval information representing at least one of one of a coincident interval and a similar speech interval and one of a non-similar interval and a non-coincident interval with respect to the rephrased speech and the original speech; and
means for instructing the computer to reconstruct the input speech using the candidate information of the rephrased speech and the original speech based on the interval information.
